(19) United States
(12) Patent Application Publication
(10) Pub. No.: US 2002/0143583 A1
(43) Pub. Date: Oct. 3, 2002

(54) Online reinsurance renewal method

(76) Inventors: Robert A. Reader, Overland Park, KS (US); James S. Murakami, Overland Park, KS (US)

Correspondence Address: SHUGHART THOMSON & KILROY, PC, 120 WEST 12TH STREET, KANSAS CITY, MO, 64105, US

(21) Appl. No.: 09/681,410

(22) Filed: Mar. 30, 2001

(51) Int. Cl. G06F 17/60

(52) U.S. Cl. 705/4; 713/201; 707/503

(57) ABSTRACT

An online reinsurance renewal method includes providing a renewal web site, accessible by a client, and including interactive web pages which display policies or reinsurance contracts of the client and their status. The client selects a contract to renew and is transferred to an underwrite page which presents underwriting questions to determine if changes have occurred relative to the insured risk which would preclude automatic renewal. If no such changes are recorded, an authorization page is displayed including the terms for renewal. The client can electronically accept the terms by selecting a bind button. If changes to the insured risk are recorded, the client is prompted to electronically provide additional information to an underwriter to complete the underwriting process.

### Background of Invention

The purpose of insurance is to redistribute risks. Insurers or risk carriers assume portions of the risks of their customers or insureds in exchange for premiums. Insureds may also be referred to as cedents in that they cede risks to a risk carrier or insurer. Reinsurance is used by insurance companies to redistribute their exposure to other insurers. In a reinsurance agreement, an insurer, often referred to as a primary insurer or ceding company, transfers or cedes some or all of its exposures and premiums to a reinsurer. The reinsurer then agrees to indemnify the ceding company for a predetermined type and amount of losses sustained. In general terms, any party that transfers risk, through either a primary insurance policy or a reinsurance contract may be referred to as a cedant or a ceding party.

It is important to understand that insurers, including primary insurers and reinsurers, are regulated as to the amount of insurance they can write, or risk that they can assume, based on the amount of surplus funds they hold. The capacity of an insurer generally refers to the monetary amount of insurance or risk of loss which the insurer can agree to cover based upon their surplus funds. An insurance company can increase its capacity to allow it to write more policies or to write policies with higher coverage limits by reinsuring a portion of the risks it is carrying.

There are two broad types of reinsurance contracts: treaty and facultative. Treaty reinsurance involves an agreement in which the primary insurer agrees in advance to cede certain classes of business or types of insurance to the reinsurer. Under a treaty reinsurance contract, the reinsurer agrees to reinsure some portion of the risk of all of the primary insurer”s insurance contracts related to a particular line of business or type of insurance. Individual risks are not underwritten or discussed. The reinsurer relies on the primary insurer to accept only risks that fall within acceptable underwriting criteria and reinsures all risks that fall within the reinsurance treaty agreement. On the other hand, facultative reinsurance involves separate reinsurance agreements for each risk or policy that is being reinsured.

In addition to the broad types of reinsurance contracts, there are various ways in which the parties may share or cede the risks. Two primary classifications of risk sharing arrangements are referred to as proportional arrangements or excess of loss arrangements. In a proportional agreement, a certain percentage of every risk covered by the agreement is ceded by the primary insurer to the reinsurer. However, in an excess of loss reinsurance agreement, only losses beyond a certain level are ceded to the reinsurer.

Historically, reinsurance contracts have been initiated by the primary insurer, or by a broker on behalf of the primary insurer, which approaches a reinsurer and requests coverage of a certain amount of its portfolio. An underwriter for the reinsurer evaluates performance data for the primary insurer and evaluates the risk associated with the requested reinsurance amount and decides how much coverage or capacity the reinsurer is willing and able to offer and under what financial and legal terms. This offer is either accepted or declined by the cedent or primary insurer. This process is typically effected by telephone, facsimile, letter, or personal contact and may involve ongoing negotiations as to the financial and legal terms or the amount of capacity offered. These are also essentially the same methods used for selling most types of insurance.

The reinsurance industry and the insurance industry, in general, operate in competitive environments. These industries are also highly regulated regarding cash reserves, premiums, and the like. To maintain business viability in such competitive and regulated circumstances, reinsurers and insurers must maximize sales of services and products and minimize costs. One way to accomplish this is to optimize the application of underwriting effort to reinsurance and insurance contracting. In many cases, where only minimal changes have occurred in the circumstances of the cedent or insured, renewal of reinsurance or insurance contracts is little more than a formality. If renewals under such circumstances could be automated, underwriting efforts could be more efficiently applied to more complex risk analysis and customer service matters.

### SUMMARY OF THE INVENTION

The present invention provides an automated reinsurance renewal system which can be implemented online by an insurer or reinsurer. Use of the automated renewal system involves three main steps to be completed by the insured party or cedant; selection of a policy to be renewed, answering underwriting questions, and allowing the cedant to authorize renewal of the insurance contract if offered based upon the response to the underwriting questions.

In the renewal method, the cedant identifies the insurance to be renewed, from a menu of policies or contracts previously entered into between the cedant and the insurer. The cedant is then electronically presented with a list of underwriting questions to identify the existence of any changes to the insured risk or ceded risk or to the cedant”s situation which would require a change in the contract. If the questions are answered in such a manner as to indicate that there are no substantial changes to the insured risk or the cedant”s situation, terms for renewal of the contract are displayed. If the terms are agreeable to the cedant, the cedant directs the system to bind the cedant and the insurer/reinsurer to a contract according to the terms previously displayed, confirmation of which is then displayed. The underwriting questions are worded to determine if changes have occurred in what is being insured which may increase exposure of the customer to insurance claims, which may increase the monetary amount of insurance claims, or which may decrease the insurability of the cedant. Such factors would normally be reviewed during conventional negotiations for renewal of a policy and could affect whether a policy is offered, the terms of the policy, and the premiums. For example, where the system is to be used for renewing facultative insurance, the underwriting questions would be drafted to address changes in the nature of the underlying insured risk and possible changes in the contractual relationship between the primary insurer (the cedant) and the reinsurer.

If the answers to any of the underwriting questions indicate a substantial change in the insured risks which would require a change to the insurance contract, the cedant is given the opportunity to enter additional explanatory information or attach additional explanatory information in the form of electronic files such as word processing documents, spreadsheets or slide presentations. Information identifying the existing contract and the changes to the cedant”s situation are then forwarded to an underwriter for further consideration. If appropriate, the underwriter can then authorize the terms under which the contract could be modified to accommodate the cedant”s changed situation or changes in the insured risk. Such modified terms may be conveyed to the customer by email or by conventional means including telephone, fax or regular mail. Under some circumstances, it may be necessary for the insurer and the cedant to negotiate an entirely new contract. However, even when an automatic renewal is not appropriate or possible, the renewal method has the advantage of allowing the cedant to provide pertinent information to facilitate resolution of the matter.

The method is preferably implemented as a secure web site with appropriate safeguards to prevent malicious or even unintended corruption of the insurer”s data, divulging customer or client information to unauthorized parties, and the like. The method is implemented as a number of interactive web pages set up to enable the entry and storage of customer information by selection or by direct entry. The method facilitates and expedites the process of insurance renewal not only for the insurer but also for customers, clients or cedants.

Objects and advantages of this invention will become apparent from the following description taken in relation to the accompanying drawings wherein are set forth, by way of illustration and example, certain embodiments of this invention.

The drawings constitute a part of this specification, include exemplary embodiments of the present invention, and illustrate various objects and features thereof.

### BRIEF DESCRIPTION OF THE DRAWINGS

FIG. 1 is a simplified block diagram illustrating an online interconnection of a cedant with an insurer for practice of an online reinsurance renewal method.

FIG. 2 is a flow diagram illustrating the principal steps in the online reinsurance renewal method.

FIG. 3 is a diagrammatic view of a selection web page for selection of an insurance contract to renew in the renewal method.

FIG. 4 is a diagrammatic view of a underwriting web page displaying underwriting questions to be answered with respect to an insurance contract to be renewed using the method.

FIG. 5 is a diagrammatic view of an authorization web page displaying details of an insurance contract to be renewed and including a button to enable a cedant to authorize binding of an insurer and the cedant to the contract terms displayed.

FIG. 6 is a diagrammatic view of a confirmation web page displaying details of a contract which has been renewed using the online reinsurance renewal method.

FIG. 7 is a diagrammatic view of a web page for obtaining additional information from a cedant regarding underwriting questions which were answered yes in FIG. 4.

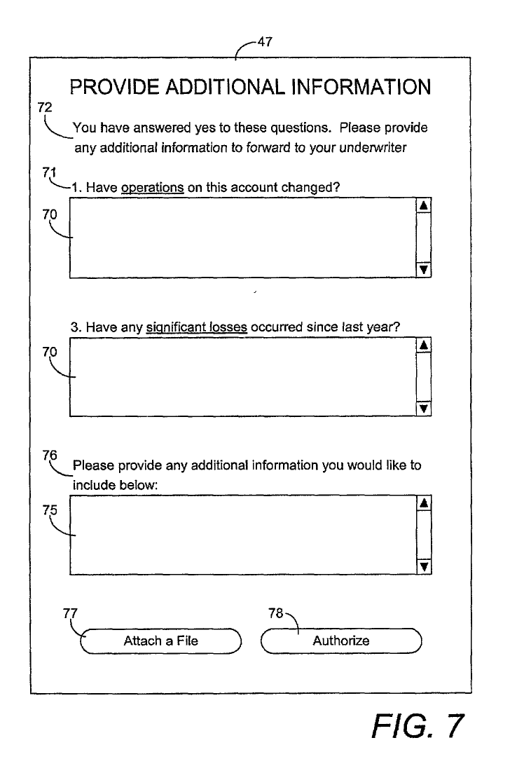

### DETAILED DESCRIPTION

As required, detailed embodiments of the present invention are disclosed herein; however, it is to be understood that the disclosed embodiments are merely exemplary of the invention, which may be embodied in various forms. Therefore, specific procedural and functional details disclosed herein are not to be interpreted as limiting, but merely as a basis for the claims and as a representative basis for teaching one skilled in the art to variously employ the present invention in virtually any appropriately detailed process or application.

For purposes of illustration, the online renewal method is described hereafter with reference to renewal of a facultative, reinsurance contract. However, it is to be understood that the online renewal method as described and claimed has applicability to the renewal of other forms of reinsurance contracts or policies as well as primary insurance contracts or policies. It should also be noted that as used herein, reinsurance is considered a form of insurance and terms such as insure, insurance and insured generally include or encompass the terms reinsure, reinsurance and reinsured respectively. In addition, the terms customer or client are generally considered synonymous, as are the terms ceding party, insured, reinsured or policy holder.

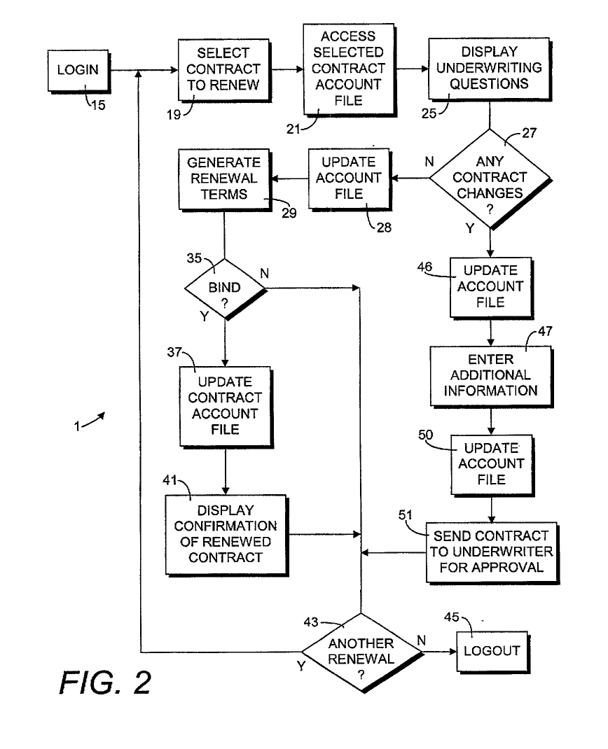

Referring to the drawings in more detail, the reference numeral 1 (FIG. 2) generally designates steps of an online reinsurance renewal method or system. The method 1 enables secure access from a client”s computer 2 to a client policy account file or client contract account file 3 over an internet connection 4 for the purpose of renewing one or more reinsurance contracts or policies maintained in the client contract account file 3. In the method 1, renewal of a reinsurance contract is facilitated by answers to a plurality of underwriting questions 5, by a client, which indicate whether or not substantial or material changes in the situation of the client or the insured risk have occurred which would affect the terms of the reinsurance contract.

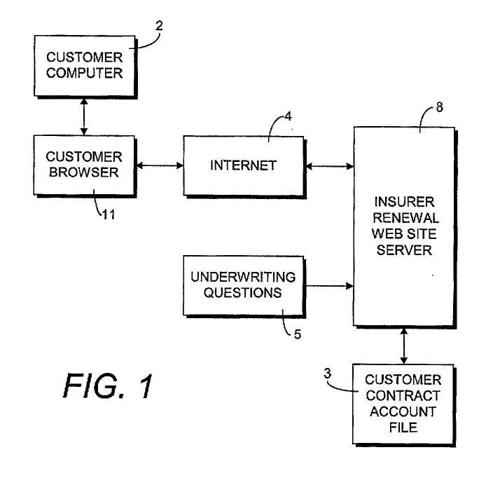

Referring to FIG. 1, the renewal method 1 is preferably capable of being practiced over a global computer network or internet 4 to enable widespread access to an insurer renewal website server 8 on which a plurality of customer policy or contract account files 3 are stored. It is foreseen that the renewal server 8 could comprise multiple servers or computers. The insurer renewal web site server 8 functions as an interactive user interface to the account files 3. As used herein, the renewal server 8, account files 3 and the software run thereon to provide access to and to permit manipulation and processing of the data stored in the account files 3 and to generate the web pages described below, may collectively be referred to as a server, system server or system.

Access to the system is provided to employees and representatives of the insurer and the insured including brokers. It is to be understood that as used in the claims, an individual insured could serve as their own representative. The server 8 preferably provides security measures to prevent unauthorized access to the account files 3, as by requiring a previously established account with a unique combination of an account number and password. The client or its representative, accesses the insurer renewal website server 8 over the internet 4, through its computer 2 using a conventional internet browser 11, which is compatible with the web site programming of the server 8.

FIG. 2 illustrates the principal steps in an online reinsurance renewal method. A login step 15 enables an existing client to log into the renewal website server 8 using the client”s browser 11 and provides access to a contract or contracts in the client”s account file 3 which the client is authorized to access by the reinsurer. The login step 15 may be accessed from a web page generated by the renewal website server 8. Preferably, the login step 15 requires the entry of unique information for each client to maintain security of the account files 3, as well as of the server 8.

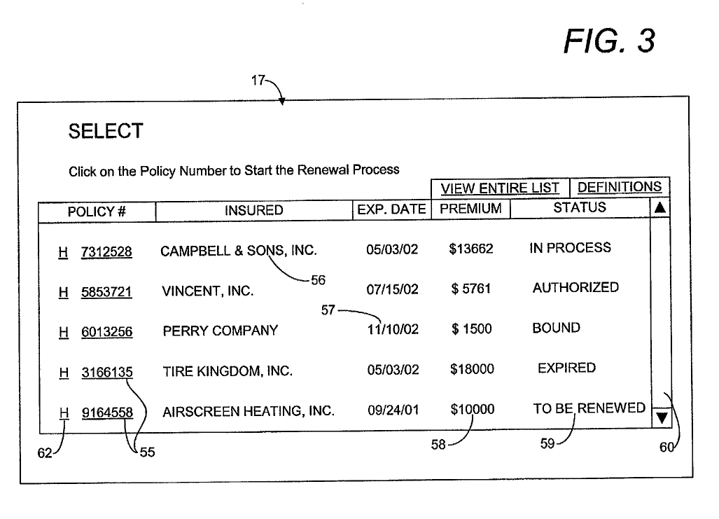

A list of the policies or contracts held by the client is displayed on a “select” web page 17 (FIG. 3) and provides identifying information and current status for the contracts as well hypertext links to enable transfer to further pages in the process 1 with the selected contract as an “argument” or subject of the renewal process. Selection of a contract for renewal at step 19 provides access by the process 1 at 21 to the client contract account file 3 associated with the contract and the data therein which will be changed or updated as a result of the process 1.

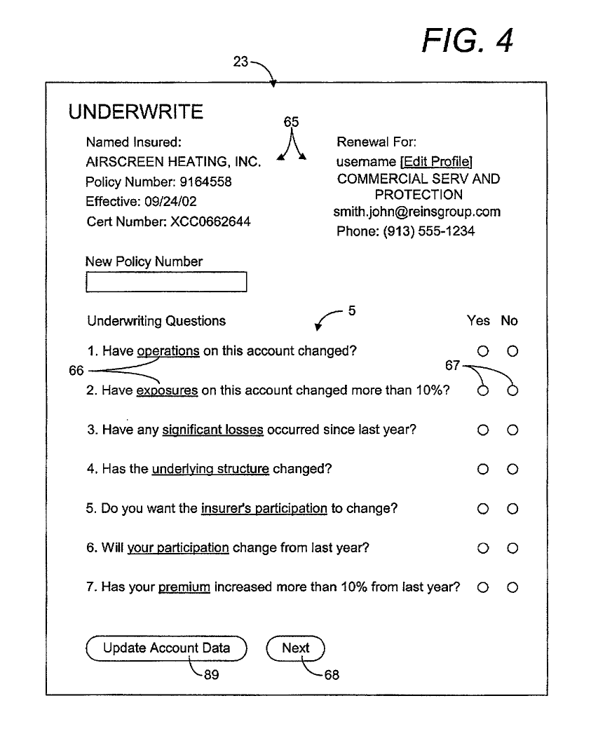

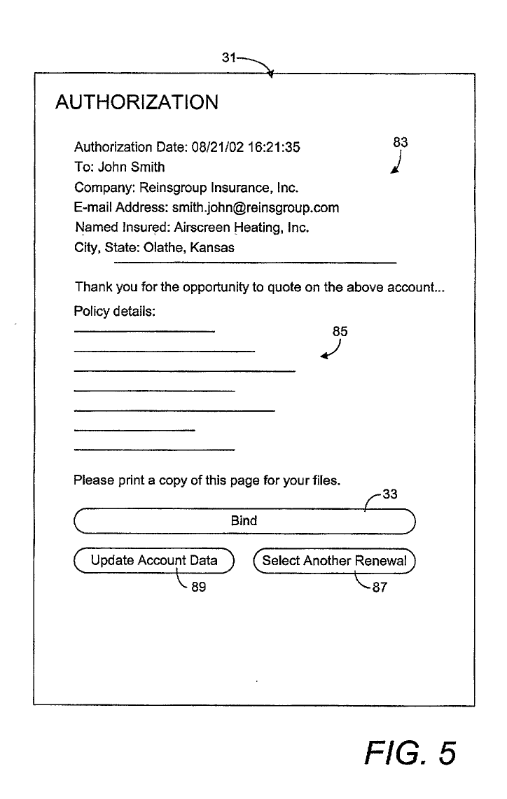

Selection of a policy or contract for renewal on the select page 17 links to an underwrite page 23 (FIG. 4) on which the underwriting questions 5 are displayed at step 25. The illustrated underwriting questions 5 are in the form of “yes/no” questions to determine if changes have occurred to the cedant or the insured risk which will affect the terms of the reinsurance contract sought to be renewed. Upon answering all of the questions, the answers to the underwriting questions 5 are reviewed at test 27, and if there are no substantial changes detected at test 27, the process 1 updates the contract account file 3 at 28 and generates and displays renewal terms for the reinsurance contract at 29 on an authorization page 31 (FIG. 5).

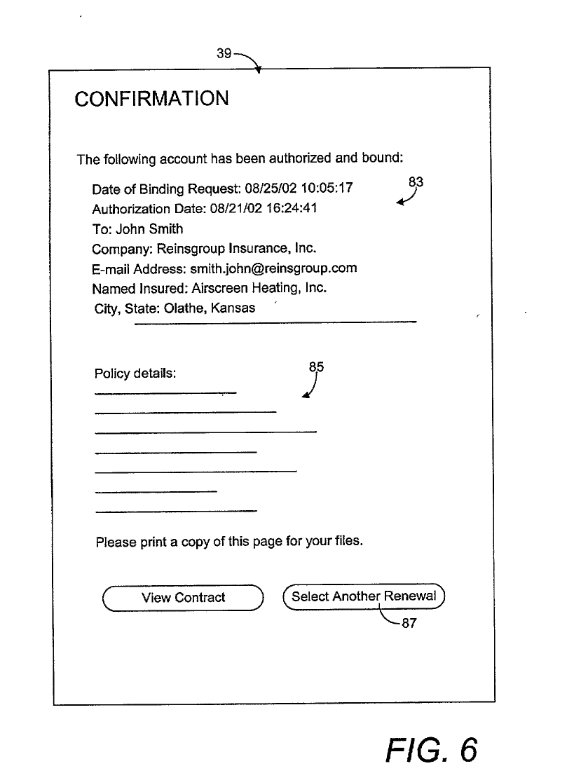

If the renewal terms are acceptable to the client, a bind “button” 33 is selected on the authorization page 31 at test 35, and the contract account file 3 is updated again at 37, causing a confirmation page 39 (FIG. 6) to be displayed at 41. The confirmation page 39 is somewhat similar to the authorization page 31, as far as displaying details related to the reinsurance contract being updated. Upon completing renewal of a given reinsurance contract, the customer may return to the select page 17 through a test 43 or logout of the renewal process 1 at 45.

If review of the underwriting questions 5 at 27 indicates that one or more of the underwriting questions 5 was answered “yes”, the account file 3 is so updated at 46 and an additional information page 47 is generated which prompts the client representative to enter explanatory information at step 49 regarding changes in the client”s or cedant”s situation or changes in the insured risk. Such changes may be generally referred to as changes in the insured risk. The contract information and the explanatory information added by the client are added to the account file 3 at step 50 and conveyed electronically at step 51 to a reinsurance underwriter for review and possible approval. The reinsurance underwriter is one specifically assigned to the client or primary insurer. Alternatively, the client could be instructed to contact a specified representative or reinsurance underwriter by other means such as mail, telephone or facsimile transmission to provide additional underwriting information relating to the change in the client”s situation or changes in the insured risk to permit further underwriting and human intervention in the renewal process.

Upon sending the additional requested information electronically or upon an indication from the user that additional information will be sent such as at test 49, the user will be prompted to indicate at test 43 whether it wants to logout at 45 or attempt to renew another reinsurance contract by returning to the selection page 17 and repeating the selection step 19.

When additional information is sent to a reinsurance underwriter at step 51, the underwriter reviews the information. If the underwriter decides that in view of the additional information, the reinsurance contract should still be made available for renewal, the underwriter sends the client an e-mail indicating that the renewal will be offered. The reinsurance underwriter has the option of changing the terms of the renewal to account for changes in the insured risk as detailed in the additional information provided. For example, the reinsurance underwriter could change the premium or limits in response to the changed circumstances. The reinsurance underwriter then modifies the contract account file 3 to record such changes and then notifies the customer of the availability of the reinsurance contract for renewal.

The e-mail sent to the client notifying it of availability for renewal of the reinsurance contract, preferably includes a hypertext link to the website with instructions prompting the user to connect to the website, login and proceed to the authorization page 31 for the contract which has been revised. If the reinsurance underwriter still needs additional information to complete the underwriting process, the underwriter can initiate further communications with the client to gather the necessary information. If the reinsurance underwriter determines that the contract should not be renewed, the underwriter sends the client a message, preferably as an e-mail, indicating that renewal of the contract has been declined, and updates the contract account file 3 with the proper account status.

Having described the basic steps of the process, provided below is additional information concerning more specific details of the process, the associated web pages and implementation of the process.

The illustrated select page 17 (FIG. 3) includes policy or contract identification numbers 55, names 56 of the policies (the name of the primary insured in the underlying insurance contract), an expiration date 57 for each policy or reinsurance contract, the premium 58 for each contract and an indication of the current status 59 of each contract. The select page 17 may include a scroll bar 60 to enable the online client to scroll among a plurality of contracts listed. The illustrated policy numbers 55 are shown underlined to indicate that they are hypertext links to another web page (not shown) which provides detailed information regarding the contract terms and related information.

As shown in FIG. 3, possible descriptions of the contract status include, “to be renewed”, “in process”, “authorized”, “bound” and “expired”. It is foreseen that additional descriptions of the contract status could include “reauthorized”, “did not renew”, or “endorsement”. Reinsurance contracts or policies which are subject to or up for renewal are identified as “to be renewed”. Links are also provided on the select page 17 to generate a list of all of the client”s policies or contracts and to generate a list of definitions.

A contract history link 62, generally represented by a capital H, is provided next to each policy number. Selecting the contract history link 62 generates a listing (not shown) of document links representative of various documents generated during the renewal process. For example, a link will be provided to the page providing the renewal terms as well as the page displaying the confirmation page. In addition, a further link is preferably provided to the responses to the underwriting questions, including any information or documents provided at step 51 on the additional information page 47. It is to be understood that it is intended that all of the documents normally associated with renewal of an insurance contract may be saved in digital form eliminating the need for paper copies. However, it is also to be understood that users of the system could print off selected pages, screens or documents as deemed necessary to facilitate review or for documentation purposes.

The system may be programmed to automatically update the status of an existing, “bound” contract to “to be renewed” at selected intervals (i.e. two to three months) prior to the expiration date. The system may also be programmed to generate a report each month for review by a reinsurance underwriter that identifies contracts which will expire in a set time period. For example, the system could be programmed to include on the underwriter”s report a listing of all those contracts set to expire in four months. The reinsurance underwriter would review this report and make determinations as to which contracts the company wants to make available for renewal and under what terms. The reinsurance underwriter would then change the status of those contracts which the company wants to make available for renewal as “to be renewed” and update the system to show the revised terms for renewal. For those contracts which the company decides not to make available for renewal, the status would be changed to indicate “not available for renewal” or a similar designation.

The client or user is instructed to routinely monitor the website, to keep track of the status of its contracts. In addition, the system may be programmed to send e-mail notices to a client when the status of one or more of its contracts is changed to “to be renewed”. The system is preferably programmed to make such updates to the status viewable by the client and to send e-mail notices to the client of the change in status at two months prior to the policy or reinsurance contract expiration date. It is to be understood that notices can be sent to notify the client of other status changes.

When the status of a contract is identified as “to be renewed”, the client can initiate the renewal process, in the manner described above, by clicking on a policy number 55 for that contract to generate the underwrite page 23 (FIG. 4) for that contract. The underwrite page 23 includes identifying information 65 for the selected contract displayed thereon and relevant underwriting questions 5.

The underwriting questions 5 displayed on the underwrite page 23 relate to the contract identified by the information 65, and the answers to the underwriting questions 5 are associated with the particular contract. The underwriting questions 5 are worded to determine if changes have occurred to either the insured or the insured risk which would affect the terms of the contract under renewal to such an extent that automatic renewal, without review by an underwriter, would not be prudent. The changes to be determined include those which might affect exposure of the insured or the primary insurer to claims, which might affect the amount of insurance required or the premium for the contract, those which might affect overall insurability of the insured, and the like.

The illustrated underwriting questions 5 are exemplary questions related to reinsurance contract renewals. Other types of insurance contract or policy renewals might require different questions more appropriate to the actual situation. Each of the questions 5 shown in FIG. 4 has an underlined word 66 which is a hyperlink to a web page (not shown) displaying explanatory information or definitions related to the particular question 5.

The underwriting questions 5 shown require a “yes” or “no” answer, by mouse clicking the appropriate circle 67, and all questions must be answered. It is conceivable that underwriting questions 5 could require quantitative or word answers which could then be scored, evaluated, or otherwise processed by the system 1 to determine if the contract renewal can be automatically approved. It is also foreseen that certain ranges of answers or certain answers could invoke popup boxes or screens for entry of explanatory information or answers to further questions. The questions 5 could also be arranged in a hierarchical manner with some required to be answered and others optional.

For exemplary purposes, the underwriting questions 5, as shown in FIG. 4 are discussed below. These questions relate to a casualty facultative contract with the named insured in the underlying policy for which renewal of the reinsurance is sought, being Airscreen Heating, Inc. The first question asks whether operations on this account have changed. Clicking on the hypertext link 66 for operations, the user is provided an explanatory definition for this question. In general, this question is seeking to determine if there have been any new ventures started by the insured since the last renewal that constitute a material change or whether the insured has any new products in the marketplace since the last renewal year that materially change the makeup of the account.

The second question asks whether exposures on the account have changed more than a given percentage determined by the reinsurance underwriter. The explanatory comment or definition for this question instructs the user to indicate whether the rating basis that is used to rate the underlying or excess policy has changed. The third question asks whether any significant losses have occurred since last year. The explanatory comment for this question instructs the user to indicate whether known or reported losses as of the last effective date of the policy exceeded a specified amount, either on an occurrence basis, an aggregate annual basis or both.

The fourth question asks whether the underlying structure has changed. The explanatory comments clarify that the user is to indicate whether there have been any changes in the underlying insurance policy relating to the limits, terms and conditions, best rating of the underlying carrier, deductible amounts or sir amounts. The fifth question asks the user to indicate whether it wants the reinsurer”s participation to change. The explanatory comments indicate that the participation includes prior years limit, percent share of the layer, ceding commission and terms and conditions. The sixth question asks the user or client to indicate whether it wants its participation to change from the last year. The explanatory comments further describe the client”s participation as prior years limit, percent share of the layer or participation on the entire account and terms and conditions.

The final or seventh question asks whether the client”s premium increased more than a certain percentage (i.e. 10%) from last year. The explanatory comments clarify that the user is to indicate whether the amount of premium for the entire layer that it and the reinsurer are participating in has changed or is to be changed. As noted previously, these questions are exemplary of the types of underwriting questions which might be asked but it is foreseen that a wide variety of questions would be appropriate depending on the nature of the contract up for renewal.

Upon answering each of the questions, the client or user selects or clicks on a next button 68 which initiates review of the answers by the system or program such as at step 27. As noted previously, if the client answers no to all of the questions, the system generates an authorization page 31 at step 29, which generally comprises an offer for renewal of the contract. If the client answers yes to any of the questions, the client will either be prompted for more information, such as at step 49, or prompted to contact an underwriter.

The client is prompted to provide additional information at step 49 through the generation of the additional information page 47. The program generates a fill-in box 70 for each of the questions for which the client answered “yes” with a copy 71 of that question associated with the box and instructions 72 to provide additional information. It is foreseen that the system could generate questions asking for specific information relating to the question or questions for which a “yes” answer was provided. The page 47 also includes a catch-all box 75 with instructions 76 instructing the client to provide any additional information it would like to submit to the reinsurance underwriter. The client types in any additional information it wants to submit to the reinsurance underwriter in boxes 70 or 75.

The additional information page 47 also preferably includes an attach file button 77 which when selected allows the client to associate electronic file with the other additional information to be submitted to the underwriter to explain the “yes” answer. The client is prompted to transmit the additional information or attached files by selecting a submit or authorize button 78 provided on the page.

Upon selecting the authorize button 78, a message is forwarded to an appropriate reinsurance underwriter or account administrator indicating that a contract which a client is seeking to renew, requires additional review or underwriting. The message includes identifying information for the policy or reinsurance contract at issue, such as the policy number, the name of the insured and information concerning the policy. The message also provides the client”s responses to each of the underwriting questions 5 and the additional information, if any, requested in response to a “yes” answer along with any files selected for attachment by the client.

Upon sending of the information to the reinsurance underwriter at step 51, the system generates a page (not shown), as generally indicated at step 43, which allows the client to choose to return to the select page 17 or logout of the renewal process 1 at 45. Generally simultaneously therewith, the client”s account file is updated to indicate that the status of the contract for which additional information was sent to the underwriter, is changed to indicate the contract is “in process”.

Upon receiving by the reinsurance underwriter of a message for a contract “in process”, the underwriter reviews the additional information provided regarding an underwriting question which was answered “yes” with reference to the terms of the contract and historical information on the insured. The reinsurance underwriter reviews this information to determine whether renewal of the contract should be authorized as originally proposed, whether renewal of the contract should be authorized under modified terms (i.e. increased premium or decreased limits), whether renewal should be declined, or whether additional information is still required.

If the reinsurance underwriter needs additional information to complete the underwriting process, the underwriter preferably makes personal contact with the client”s representative by phone to obtain the necessary information or explain what information will be necessary. However, it is foreseen that the underwriter could continue to communicate with the representative by e-mail or other means to obtain the information. If the reinsurance underwriter determines that because of the changed circumstances identified through the responses to the underwriting questions 5, that the contract should not be renewed, the underwriter changes the status associated with the contract in the system as “declined”. The reinsurance underwriter, also preferably informs the client of the declination in writing, such as by e-mail or regular mail.

If the reinsurance underwriter determines that renewal of the contract can be authorized but on revised terms, the underwriter accesses the account file through the system server, and modifies the terms accordingly. For example, the underwriter may determine that the renewal can be authorized by increasing the premium, and the underwriter would take steps to modify the account file to reflect the increased premium.

When the reinsurance underwriter determines that renewal of the contract should be authorized as originally proposed or under the modified terms, the underwriter sends an e-mail to the client indicating such. The e-mail preferably includes a listing of the terms of the renewal and instructions for the client to access the authorization page 31 by logging into the system and selecting the respective policy number from the select page 17. The system will then generate the authorization page 31 reflecting the terms upon which renewal has been authorized. Upon sending the e-mail, the reinsurance underwriter, will concurrently therewith, access the account file for the contract and change the account status to “authorized”. It is foreseen that the e-mail message sent to the client, indicating renewal has been authorized, could contain a hypertext link with instructions, instructing the user to select the link to connect to the secured homepage, login and proceed to the authorization page 31 for the contract in question.

The authorization page 31 and confirmation page 39 are similar, although they have different functions. Both include contract identification information and at least enough contract details or terms 85 for the client to make a decision to renew the contract. The contract details 85 (shown diagrammatically as lines in FIGS. 5 and 6) may include or identify such factors as the type of contract, any riders or exclusions, the date range the contract is in effect, monetary insurance limits, premium, and other factors. The renewal contract terms 85 may be substantially the same as those of the contract prior to renewal, or may be different in some respects.

The renewal method 1 is practiced with the assumption that clients using it will provide accurate and honest information in relation to the underwriting questions 5 and other queries for information. The authorization page 31 may display a warning that inaccurate or false information may jeopardize the contract or the payment of claims on the contract and may, in some cases, subject the user to civil and/or criminal liabilities.

If the details and terms 85 of the contract as displayed on the authorization page 31 meet with the satisfaction of the client, the client”s representative can electronically accept the terms and cause the contract to be renewed by selection of the bind button 33 displayed on the authorization page 31. If further consideration by the client is required, the client can select another contract for renewal by mouse clicking an “another renewal” button 87, can update data related to the account by selecting an “update” button 89, or can exit the process 1 altogether by logging onto another web site. An update button 69 is also provided on the underwrite page 23 to allow the client to update account information from the underwrite page 23.

Referring again to the authorization page 31 of FIG. 5, selecting the bind button 33 causes the client contract account file 3 associated with the contract to be updated to the details and terms 85 of the contract as displayed and causes the confirmation page 39 to be accessed. The status of the contract (as shown on the select page 17 of FIG. 3) is also changed to indicate that the contract has been “bound”. Additional actions can be initiated by operation of the bind button 33, such as generation of an invoice to bill the client for the premium or an installment thereof, the generation of a formal insurance contract document defining the policy contract, the generation of an electronic message to an underwriter or agent regarding the contract renewal, or the like. The confirmation page 39 is displayed to confirm to the client that the contract renewal has occurred and the details and terms 85 under which the renewal has occurred.

Both the authorization page 31 and the confirmation page 39 include instructions directing the client to print copies of these pages for its files. Links, not shown are preferably provided to permit the client to access and print all of the terms of the contract to be renewed or the terms of the contract as renewed.

If the client does not bind a contract for renewal before the contract expires, the status is automatically changed to “expired”. The reinsurance underwriter is encouraged to contact the client to confirm that the client intended not to renew the reinsurance contract. If such confirmation is made, the underwriter preferably changes the status to “did not renew”. It is foreseen that the underwriter or account representative could attempt to persuade the client to renew the reinsurance contract even after the initial expiration date. It is also foreseen that the system could be programmed to send multiple reminders to the client to notify it of the approaching expiration date. It is also foreseen that the system could be programmed to notify the appropriate account representative or underwriter if the contract has not been renewed within a preset time period prior to expiration to allow the account representative to personally contact the client to try to sell the renewal.

It is to be understood that as a preliminary step to utilization of the renewal process, the insurer preferably requires the users or customers to enter into a contract governing use of the system for renewing existing insurance contracts. In particular, the contract governing use preferably includes provisions by which the client agrees that it will be bound by the terms of any contract renewed using the system, despite the absence of an actual signature. For example, the terms may specify that the use of the user”s login and password are the equivalent to the user having signed the reinsurance renewal contract.

The renewal process and system as disclosed is advantageous in that it reduces the amount of time required by the underwriter and the client or its representative (such as a broker) to renew those contracts which would be renewed without the need for further underwriting. And in those situations where only a minor amount of additional underwriting information is required, the process and system can expedite and facilitate the processing of that information. In addition, the system permits more efficient tracking of the status of a client”s contracts by the client, the insurer or a broker.

It is to be understood that while certain forms of the present invention have been illustrated and described herein, it is not to be limited to the specific forms or arrangement of parts described and shown. For example, the pages shown are generally simplified versions of the pages as they will actually appear. The pages may include buttons or the like to allow the user to suspend or short circuit the renewal process at any point to attend to other matters or obtain additional information. The pages also may include links to additional resource information such as the identification of representatives of the insurer which have responsibility for the client”s account and links to related or informational websites. Additional functionality may also be designed into the pages to facilitate use of the system.

What is claimed is:

1. A method for renewing an insurance contract for an insured risk comprising the steps of:
storing data associated with said insurance contract in a system server by an insurer;
providing electronic access to said system server by way of a website;
allowing a representative of a ceding party to said contract to access said system server to renew said contract;
upon said representative accessing said system server to renew said contract, displaying through said website at least one question to determine if a change has occurred with respect to said insured risk which would affect terms of said contract;
prompting said representative to answer said at least one question;
upon said representative answering said question through said website in such a manner as to indicate no substantial change which would affect terms of said contract, generating by said system server,
renewal terms for renewal of said contract and displaying said renewal terms on said website; and
allowing said representative to electronically accept said renewal terms through said website.

2. The method as set forth in claim 1 and including the step of:
upon acceptance of said renewal terms by said representative, generating by said system server and displaying on said website a confirmation message regarding renewal of said contract.

3. The method as set forth in claim 1 further including the steps of:
upon said representative responding to said question through said website in such a manner as to indicate a change with respect to said insured risk which would affect terms of said contract, providing on said website means to enable entry of explanatory information by said representative regarding said change; and
providing means for said representative to electronically convey said explanatory information to an underwriter of said insurer.

4. The method as set forth in claim 1 wherein said step of allowing a representative of a ceding party to said contract to access said system server to renew said contract includes providing a listing of contracts of said ceding party including an indication of whether said contract is subject to renewal or whether said contract has been renewed.

5. A method for renewing an insurance contract comprising the steps of:
storing data associated with said insurance contract in a system server;
providing electronic access to said system server by way of a website;
upon a representative of a ceding party to said contract accessing said system server to renew said contract, displaying through said website a plurality of underwriting questions which can be answered yes or no to determine if a change has occurred with respect to an insured risk which would affect terms of said contract;
upon said representative of said ceding party responding no to each of said underwriting questions through said website indicating no change has occurred with respect to an insured risk, generating by said system server renewal terms to enable renewal of said contract and displaying said renewal terms on said website; and
allowing said representative to electronically accept said renewal terms through said website.

6. The method as in claim 5 further including the step of:
upon acceptance of said renewal terms by said representative, generating by said system server and displaying on said website a confirmation message regarding renewal of said contract.

7. The method as in claim 5 further including the steps of:
upon said representative answering yes to one of said underwriting questions indicating a change with respect to said insured risk, providing on said website means to enable entry of explanatory information by said representative regarding said change; and
electronically conveying a message regarding said contract, said change, and said explanatory information to an underwriter of said insurer.

8. The method as set forth in claim 5 wherein said step of allowing a representative of a ceding party to said contract to access said system server to renew said contract includes providing a listing of contracts of said ceding party including an indication of whether said contract is subject to renewal or whether said contract has been renewed.

9. A method for renewing an insurance contract and comprising the steps of:
storing in a system server data associated with a plurality of insurance contracts issued to a ceding party by an insurer;
providing secure internet access to said system server by way of a website;
providing access through said website to a listing of said insurance contracts issued to said ceding party, wherein said listing for each contract includes an indication of a status of each said contract including an indication if said contract is available for renewal;
allowing said representative to electronically select for renewal one of said contracts from said listing;
upon said representative selecting one of said contracts for renewal, displaying through said website a plurality of underwriting questions, which can be answered yes or no, to determine if a change has occurred with respect to said insured risk which would affect the underwriting of said contract;
upon said representative of said ceding party responding no to each of said underwriting questions through said website indicating no change has occurred with respect to an insured risk, generating by said system server renewal terms to enable renewal of said contract and displaying said renewal terms on said website;
allowing said representative to electronically accept said renewal terms through said website;
generating by said system server and displaying on said website a confirmation message confirming renewal of said contract;
upon said representative answering yes to one of said underwriting questions indicating a change with respect to said insured risk, providing on said website means to enable entry of explanatory
information by said representative regarding said change; and electronically conveying a message regarding said contract, said change, and said explanatory information to an underwriter of said insurer.
